(19) United States
(12) Patent Application Publication
(10) Pub. No.: US 2024/0316599 A1
(43) Pub. Date: Sep. 26, 2024

(54) Roll Cleaning Device

(71) Applicant: LG Energy Solution, Ltd., Seoul (KR)

(72) Inventor: Kang Ho Seong, Daejeon (KR)

(73) Assignee: LG Energy Solution, Ltd., Seoul (KR)

(21) Appl. No.: 18/575,054

(22) PCT Filed: Sep. 15, 2022
(86) PCT No.: PCT/KR2022/013746

§ 371 Date: Dec. 28, 2023

(30) Foreign Application Priority Data
Sep. 15, 2021 (KR) 10-2021-0122831

(51) Int. Cl. B08B 1/16; B08B 1/34

(52) U.S. Cl. CPC B08B 1/165; B08B 1/34

(57) ABSTRACT

A roll cleaning device according to one example of the present invention comprises at least one knife, wherein the at least one knife comprises a cleaning part surrounding a target roll to be in contact with the outer circumferential surface of the target roll on which foreign substances are present, and an operating part, which is connected to the cleaning part, for moving the at least one knife along the circumferential direction on the outer circumferential surface of the target roll.

### TECHNICAL FIELD

The present invention relates to a roll cleaning device and a roll cleaning method, and more particularly, to a roll cleaning device and a roll cleaning method that can be operated at a location far away from a target roll when removing foreign substances present on the target roll.

This application claims the benefit of priority based on Korean Patent Application No. 10-2021-0122831 dated Sep. 15, 2021, the disclosure of which is incorporated herein by reference in its entirety.

### BACKGROUND ART

In general, the surfaces of various rollers used in production sites such as steel mills, papermaking, printing, film, food, and chemical plants are smeared with coolant, or various types of foreign substances such as scale, dust, and oil depending on the manufacturing process and working environment.

These foreign substances cause transfer (mark) and contamination on the surface of the product passing through the roller, and thus eventually cause product defects.

In addition, when the equipment is operated for a long time with foreign substances on the surface of the roller, the surface of the roller is easily damaged or broken.

Accordingly, a roller surface foreign material removal device capable of removing foreign substances smeared to the surface of the roller is used. An example of a conventionally used roller surface foreign material removal device has been disclosed in Korean Patent Publication No. 10-2012-0091730 “A roller surface foreign material removal device provided with a foreign material blocking member”.

FIG. 1 is a schematic diagram schematically illustrating an operation process of a conventional roller surface foreign material removal device. As shown, in the conventional foreign material removal device (10), the blade (2) is in contact with the surface of the roller (A) at an inclined angle to remove the foreign material (B) on the surface of the roller (A).

However, in the conventional roller surface foreign material removal device as disclosed, the blade holder (1) is fixedly disposed on one side of the roller (A). That is, the blade (2) is fixed at a position where it can come into contact with the surface of the roller (A). Accordingly, when the roller (A) has to be separated from the roller rotation shaft for repair and replacement of the roller (A), there was a problem that it became difficult to repair due to the interference with the blade (2).

### DISCLOSURE

### Technical Problem

It is an object of the present invention to provide a roll cleaning device and a roll cleaning method that can be operated even at a location far away from a target roll when removing foreign substances present on the target roll.

It is another object of the present invention to provide a roll cleaning device that is detachably installed with respect to a target roll and can clean a plurality of target rolls without being limited to a specific target roll.

### Technical Solution

A roll cleaning device according to one example of the present invention comprises at least one knife, wherein the at least one knife comprises a cleaning part surrounding a target roll to be in contact with the outer circumferential surface of the target roll on which foreign substances are present, and an operating part, which is connected to the cleaning part, for moving the at least one knife along the circumferential direction on the outer circumferential surface of the target roll.

The cleaning part may comprise a cleaning body provided to surround the target roll, a rotary gear, on which the at least one knife is mounted, disposed on the cleaning body rotatably along the inner circumferential surface of the cleaning body facing the target roll, and a driving gear gear-coupled to the rotary gear, wherein an operating shaft is connected to the operating part, thereby transmitting rotational force transmitted from the operating part to the rotary gear.

Also, the at least one knife may be provided to protrude toward the target roll through a movement passage formed through the inner circumferential surface of the cleaning body.

In addition, a blade part may be elastically supported to be movable in a direction closer to or away from the target roll.

Furthermore, the cleaning body may comprise a first body provided to surround a portion of the target roll, a second body provided to surround the remaining portion of the target roll, and a body hinge shaft for hinge-coupling one end of the first body to one end of the second body.

Also, the cleaning body may comprise a first fastening member installed at the other end of the first body; and a second fastening member installed at the other end of the second body and detachably united to the first fastening member.

In addition, the rotary gear may comprise a first gear disposed in the first body, a second gear disposed in the second body, and a gear hinge shaft for hinge-connecting the first gear and the second gear.

Furthermore, when the first body and the second body are separated around the body hinge shaft, the first gear and the second gear may be provided to be separated around the gear hinge shaft.

The operating part may comprise an extension member, one end of which is coupled to the operating shaft of the driving gear to rotate together with the driving gear, and an operating member which is coupled to the other end of the extension member to provide rotational force to the extension member at a position spaced apart from the target roll.

Also, the operating member may comprise a manually operated operation handle or a driving motor.

In addition, the operating member may be provided to be rotatable in a forward direction and a reverse direction.

Furthermore, the cleaning part may comprise a plurality of guide gears, which is disposed within the cleaning body to be idle-rotatable, disposed apart at predetermined intervals along the circumferential direction of the rotary gear, and gear-coupled to the rotary gear.

### Advantageous Effects

As described above, the roll cleaning device and the roll cleaning method related to at least one example of the present invention have the following effects.

When removing foreign substances from the target roll, it can be operated even at a location far away from the target roll. Specifically, during the roll cleaning process, the worker can perform the cleaning work of the target roll in a space other than the space where the target roll requiring cleaning is installed, so that it is possible to perform the cleaning work of the target roll without being restricted by the space in which the target roll is installed.

The cleaning device is detachably installed for the target roll, so that a plurality of target rolls can be cleaned without being limited to a specific target roll.

### DESCRIPTION OF DRAWINGS

FIG. 1 is a diagram for schematically explaining an operating state of a foreign material removal device according to the prior art.

FIG. 2 is a diagram for schematically explaining a state diagram in which a roll cleaning device according to one example of the present invention is installed on a target roll.

FIG. 3 schematically shows a cross section A-A of FIG. 2.

FIGS. 4 and 5 are diagrams for explaining the structure of the cleaning part according to one example of the present invention.

FIGS. 6 and 7 are diagrams schematically illustrating a cross section X-X and a cross section Y-Y of FIG. 5.

FIG. 8 schematically shows a side view of a roll cleaning device according to a preferred example of the present invention.

FIG. 9 is a diagram for explaining, in one example of the present invention, an operating state of the cleaning part when the operating part is operated.

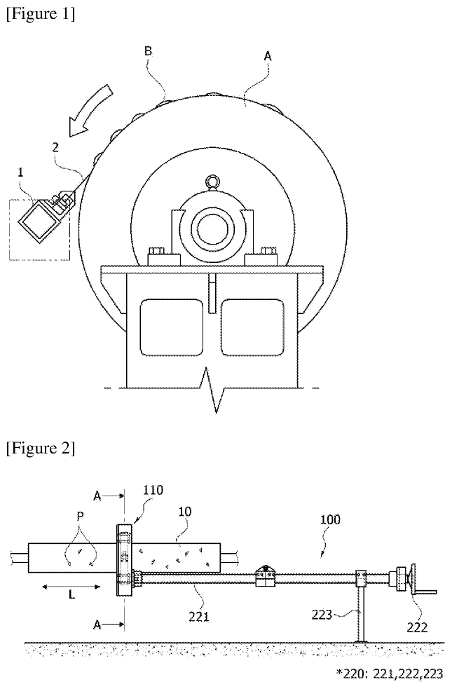

### MODE FOR INVENTION

The present invention can be subjected to various modifications and can have various examples, whereby specific examples will be illustrated and described in the drawings.

The terms of first, second, and the like may be used to describe various components, but the components should not be limited by the terms. The terms are used only for the purpose of distinguishing one component from another component.

The terms used in the present application are used only to describe specific examples, and are not intended to limit the present application. The singular expression includes the plural expression, unless the context clearly dictates otherwise.

In the present application, the terms of “comprises” or “have”, and the like are intended to designate that the features, numbers, steps, operations, components, parts, or combinations thereof described in the specification exist, but the presence or addition possibility of one or more other features, or numbers, steps, operations, components, parts, or combinations thereof must be not excluded in advance.

Also, in the present application, the accompanying drawings are illustrated to be enlarged or reduced for convenience of description.

Hereinafter, a roll cleaning device and a roll cleaning method according to one example of the present invention will be described with reference to the accompanying drawings.

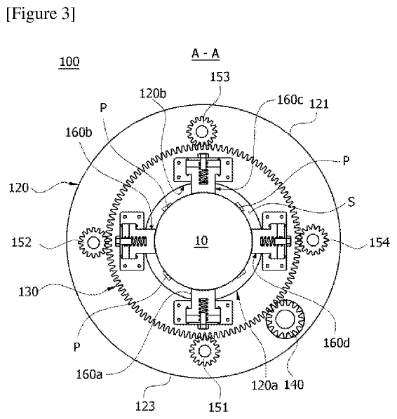

FIG. 2 is a diagram for schematically explaining a state diagram in which a roll cleaning device according to one example of the present invention is installed on a target roll, and FIG. 3 schematically shows a cross section A-A of FIG. 2.

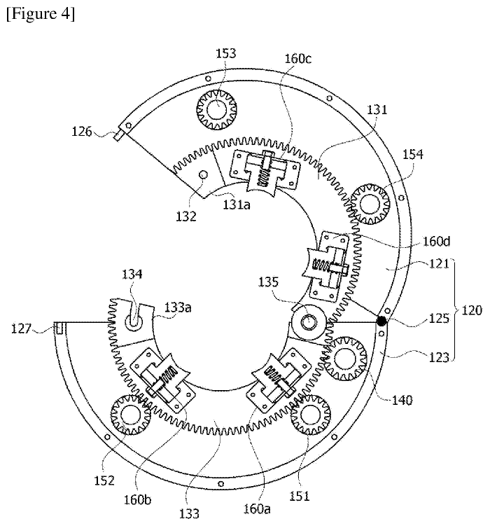

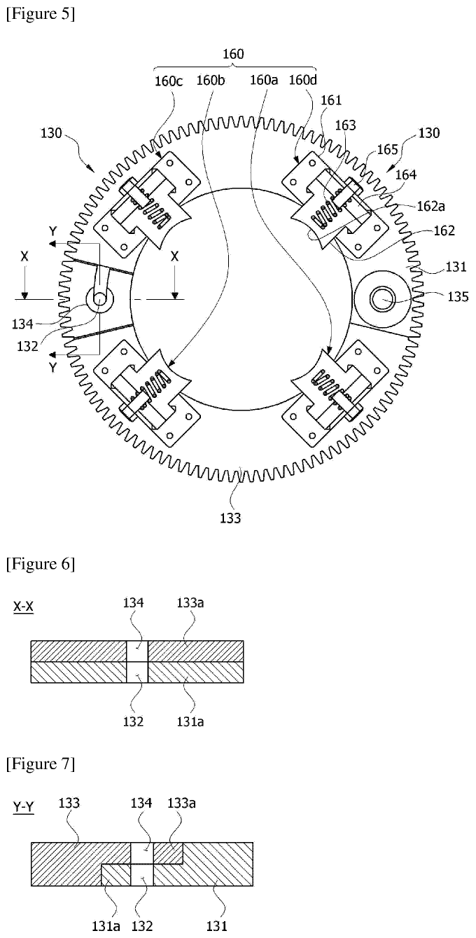

In addition, FIGS. 4 and 5 are diagrams for explaining the structure of the cleaning part according to one example of the present invention, and FIGS. 6 and 7 are diagrams schematically illustrating a cross section X-X and a cross section Y-Y of FIG. 5.

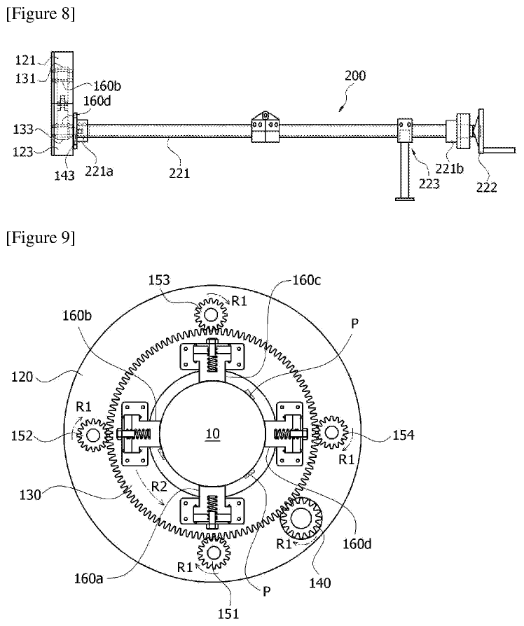

Furthermore, FIG. 8 schematically shows a side view of a roll cleaning device according to a preferred example of the present invention, and FIG. 9 is a diagram for explaining, in one example of the present invention, an operating state of the cleaning part when the operating part is operated.

The roll cleaning device according to one example of the present invention can be operated even at a location far away from a target roll when removing foreign substances present on the target roll.

The roll cleaning device (100) according to one example of the present invention comprises a cleaning part (110), and an operating part (220).

Referring to FIGS. 2 and 3, the roll cleaning device (100) comprises at least one knife (160: 160a, 160b, 160c, 160d), and comprises a cleaning part (110) surrounding the target roll (10) so that the at least one knife (160: 160a, 160b, 160c, 160d) contacts the outer circumferential surface of the target roll (10) on which the foreign substances (P) are present.

In addition, the roll cleaning device (100) comprises an operating part (220), which is connected to the cleaning part (110), for moving the at least one knife (160: 160a, 160b, 160c, 160d) along the circumferential direction on the outer circumferential surface of the target roll (10).

Through the operating part (220), the at least one knife (160) may be rotated and moved along the circumferential direction of the target roll (10) on the outer circumferential surface of the target roll (10), and the knife (160) may scrape the foreign substances (P) present on the outer circumferential surface of the target roll (10).

That is, the knife (160) may be a scraper. When operating with the operating part (220), the knife (160) maintains to be in contact with the outer circumferential surface of the target roll (10) along the circumferential direction of the target roll (10), and rotates and moves along the circumferential direction of the target roll (10) based on the center of the target roll (10).

Referring to FIG. 2, the cleaning part (110) may be provided to be movable along the longitudinal direction (L) of the target roll (10). In addition, the cleaning part (110) may be provided to surround at least a portion of regions along the longitudinal direction of the target roll (10). In this structure, by operating the cleaning part (110) while moving the cleaning part (110) along the longitudinal direction (L) of the target roll (10), it is possible to clean the entire region of the target roll (10) along the longitudinal direction (L) of the target roll (10).

That is, the roll cleaning device (100) controls the operation of the cleaning part (110) through the operating part (220) in a state where the cleaning part (110) is installed on the target roll (10), whereby the foreign substances (P) present on the target roll (10) may be crapped and removed.

Referring to FIGS. 3 to 5, the cleaning part (110) comprises a cleaning body (120), a rotary gear (130), a driving gear (140), at least one knife (160a˜160d) and at least one guide gear (151, 152, 153, 154).

Specifically, the cleaning part (110) comprises a cleaning body (120) provided to surround the target roll (10), a rotary gear (130), on which the at least one knife (160) is mounted, disposed on the cleaning body (120) rotatably along the inner circumferential surface (120a) of the cleaning body (120) facing the target roll (10), and a driving gear (140) gear-coupled to the rotary gear (130), wherein an operating shaft is connected to the operating part (220), thereby transmitting rotational force transmitted from the operating part (220) to the rotary gear (130).

Referring to FIGS. 3 and 4, the cleaning body (120) has a shape surrounding the target roll (10). The cleaning body (120) has a cleaning space (S) that the target roll (10) is disposed therein. The cleaning space (S) may have a diameter larger than the diameter of the target roll (10), and the cleaning body (120) may have a donut shape having an inner diameter larger than the diameter of the target roll (10) in a state where it surrounds the target roll (10). In addition, the cleaning body (120) may be manufactured to meet the specifications of the target roll (10).

A movement passage (120b) is provided on the inner circumferential surface (120a) of the cleaning body (120) along the circumferential direction of the cleaning body (120) (or the circumferential direction of the target roll). Here, the movement passage (120b) is a passage for guiding the rotational movement of the at least one knife (160a˜160d) along the circumferential direction of the target roll (10) based on the center of the target roll (10). The at least one knife (160a˜160d) is provided to protrude toward the outer circumferential surface of the target roll (10) through the movement passage (120b) formed through the inner peripheral surface (120a) of the cleaning body (120).

The movement passage (120b) may also be continuously formed along the circumferential direction of the target roll (10) on the inner circumferential surface (120a) of the cleaning body (120) so that the at least one knife can rotate 360 degrees along the circumferential direction of the target roll (10). Alternatively, the movement passage (120b) may also be formed in a portion of regions of the inner circumferential surface (120a) of the cleaning body (120) so that the at least one knife can rotate within a predetermined angle along the circumferential direction of the target roll (10).

In this structure, when the cleaning body (120) is disposed to surround the target roll (10), the at least one knife (160a˜160d) protrudes toward the outer circumferential surface of the target roll (10) through the movement passage (120b) formed through the inner circumferential surface (120a) of the cleaning body (120), and contacts the outer circumferential surface of the target roll (10).

The cleaning body (120) may be detachably installed on the target roll (10), and the cleaning body (120) may comprise a first body (121), a second body (123), a body hinge shaft (125), a first fastening member (126), and a second fastening member (127).

Specifically, the cleaning body (120) may comprise a first body (121) provided to surround a part of the target roll (10), a second body (123) provided to surround the remaining part of the target roll (10), and a body hinge shaft (125) for hinge-coupling one end of the first body (121) to one end of the second body (123).

The first body (121) and the second body (123) may be united to have a donut cross-section. The first body (120a) has a shape surrounding a part of the target roll (10). The second body (123) may form a cleaning space (S) with the first body (121) while surrounding the remaining part of the target roll (10).

The body hinge shaft (125) hinge-connects one end of the first body (121) and one end of the second body (123). While the first body (121) and the second body (123) are rotated at a predetermined angle around the body hinge shaft (125), the other end of the first body (121) and the other end of the second body (123) may be separated from each other, or may be close to each other. That is, in order to position the target roll (10) in the cleaning space (S), the other end of the first body (121) and the other end of the second body (123) are separated from each other, and for cleaning, when the target roll (10) is surrounded, the other end of the first body (121) and the other end of the second body (123) are close to each other.

The first fastening member (126) is installed at the other end of the first body (121), and the second fastening member (127) united to the first fastening member (126) is installed at the other end of the second body (123). The first and second fastening members (126, 127) may be detachably united. For example, the first and second fastening members (126, 127) may be configured of a hook part and a catcher part, which are known means.

When the first fastening member (126) and the second fastening member (127) are united, the first body (121) and the second body (123) maintain a state where the cleaning space (S) is formed. After the cleaning is completed, when the first fastening member (121) and the second fastening member (127) are released, the first body (121) and the second body (123) are separated at a predetermined angle around the body hinge shaft (125) so that the cleaning body (120) can be separated from the target roll (10).

The rotary gear (130) is embedded into the cleaning body (120). The rotary gear (130) is rotatably disposed in the cleaning body (120) along the inner circumferential surface (120a) of the cleaning body (120). The rotary gear (130) has a substantially ring shape. An installation space in which the rotary gear (130) is accommodated is provided in the cleaning body (120), where the installation space is formed larger than the rotary gear (130). In addition, in the installation space, the guide gears (151˜154) may be arranged to be idle-rotatable.

In addition, the rotary gear (130) may be arranged such that at least a portion of regions is supported by the inner circumferential surface (120a) of the cleaning body (120). As described below, upon the cleaning, the rotary gear (130) is rotated by the rotation of the driving gear (140) while being supported by the inner circumferential surface (120a) of the cleaning body (120) and the guide gears (151˜154). In the rotary gear (130), the gear part is not formed in the inner peripheral region where the inner circumferential surface (120a) of the cleaning body (120) faces, and the gear part is formed in the outer peripheral region opposite to the inner peripheral region. As described above, the gear part of the rotary gear (130) is gear-coupled to the driving gear (140) and the guide gears (151˜154), respectively.

The at least one knife (160: 160a˜160d) is mounted on the rotary gear (130), where the at least one knife (160a˜160d) protrudes toward the outer circumferential surface of the target roll (10) through the movement passage (120b) formed through the inner circumferential surface (120a) of the cleaning body (120), and contacts the outer circumferential surface of the target roll (10).

The rotary gear (130) has a structure that opens together when the cleaning body (120) is opened. To this end, the rotary gear (130) comprises a first gear (131) disposed in the first body (121), a second gear (133) disposed in the second body (123), and a gear hinge shaft (135) for hinge-coupling the first gear (131) and the second gear (132).

The first gear (131) and the second gear (133) are connected to each other to have a ring shape, and are rotatably disposed on the inner circumferential surface of the cleaning body (120). The first gear (131) and the second gear (133) are hinge-coupled by the gear hinge shaft (135) to have a structure that they are separated at a predetermined angle around the gear hinge shaft (135). In this structure, when the first body (121) and the second body (123) are separated around the body hinge shaft (125), the first gear (131) and the second gear (133) are separated around the gear hinge shaft (135), where the target roll (10) can enter the cleaning space (S) through the separated space.

In addition, a first fastening part (132) is provided at the end (131a) of the first gear (131) that is not hinge-coupled, and a second fastening part (134) is provided at the end (133a) of the second gear (133) that is not hinge-coupled. As one example, in the rotary gear (130), the first fastening part (132) and the second fastening part (134) are connected, whereby the end of the first gear (131) and the end of the second gear (133) may be engaged and connected. For example, referring to FIGS. 6 and 7, the first gear (131) and the second gear (133) may have a stepped structure which can be inserted into each other so that their ends are disposed by overlapping each other. Furthermore, the first fastening part (132) and the second fastening part (134) may be configured in a known structure capable of being united, where for example, the first fastening part (132) may be formed of a protrusion, and the second fastening part (134) may also be formed of a groove into which the protrusion is inserted, and both the first fastening part (132) and the second fastening part (134) may be formed of fastening holes, and in this case, the first gear (131) and the second gear (133) may be united through a pin or the like which is inserted in the fastening holes (see the examples shown in FIGS. 6 and 7).

The cleaning part (110) comprises a plurality of guide gears (151˜154), which is disposed to be idle-rotatable in the cleaning body (120), disposed apart at predetermined intervals along the circumferential direction of the rotary gear (130), and gear-coupled to the rotary gear (130). In addition, the driving gear (140) and at least one guide gear (151˜154) are gear-coupled to the outer circumferential surface of the rotary gear (130). The driving gear (140) and the plurality of guide gears (151˜154) are rotatably provided in the cleaning body (120) at fixed positions.

The driving gear (140) is gear-coupled to the rotary gear (130) to transmit the rotational force to the rotary gear (130). An extension member (221) of the operating part (220) is coupled to an operation shaft (143) of the driving gear (140). The extension member (221) may be detachably coupled to the operation shaft (143) of the driving gear (140). In addition, the operating shaft (143) means a rotation shaft of the driving gear (140).

The plurality of guide gears (151˜154) is gear-coupled to the rotary gear (130). The guide gear guides the rotation of the rotary gear (130) while idling during the rotation of the rotary gear (130).

The plurality of guide gears (151˜154) is radially arranged based on the center of the cleaning body (120).

The at least one knife (160: 160a˜160d) is mounted on the rotary gear (130). The at least one knife (160a˜160d) is moved together with the rotary gear (130) in the rotational direction of the rotary gear (130).

In the at least one knife (160a˜160d), one end is coupled to the rotary gear (130), and the other end is installed in the cleaning body (120) so that it passes through the movement passage (120b) and protrudes toward the target roll (10) through the inner circumferential surface (120a) of the cleaning body (120). As described above, the movement passage (120b) is a passage (or opening) provided on the inner circumferential surface of the cleaning body (120) along the circumferential direction of the cleaning body (120). The plurality of knives (160a˜164d) is embedded in the cleaning body (120), and the plurality of knives (160a˜164d) is disposed apart at predetermined intervals along the circumferential direction of the target roll (10).

The knife (160a˜164d) has a blade part (162) in contact with the outer circumferential surface of the target roll (10). The blade part (162) may be elastically supported to be movable in a direction closer to the target roll (10) or away from the target roll (10). As one example, referring to FIG. 5, the knife (160) may comprise a base part (161) mounted on the cleaning body (120), a blade part (162) disposed in the base part (161) to be movable in a direction closer to the target roll (10) or away from the target roll (10), and an elastic member (163) disposed to pressurize the blade part (162) in a direction closer to the target roll. The elastic member (163) may be provided to pressurize the blade part (162) in a direction closer to the target roll (10). In addition, the knife (160) may comprise a holder (165) to which the elastic member (163) is fixed, and a support member (164) disposed in the base part and mounted by the holder (165).

The plurality of knives (160a˜160d) is radially arranged based on the center of the cleaning body (120), and each is coupled to protrude toward the outer circumferential surface of the target roll (10). At this time, according to the structure in which the blade part (162) is pressurized in a direction closer to the target roll (10), the knife (160) may maintain a state where the blade part (162) is in contact with the outer circumferential surface of the target roll (10).

In each of the knives (160a˜160d), the contact region (162a) of the blade part (162) in contact with the target roll (10) has an arc shape. The blade part (162) may have a contact region (162a) curved with a predetermined curvature, and the blade part (162) may have a shape in which the center portion of the contact region (162a) is recessed inward. In addition, the blade part (162) may be curved so that the contact region (162a) has the same curvature as that of the outer circumferential surface of the target roll (10). In this structure, when the foreign substances are removed, only the foreign substances can be scraped off in the process that the knife (160) is moved along the target roll (10), and damage to the surface of the target (10) can be prevented.

The operating part (220) is connected to the cleaning part (110) to perform a function to operate the position of the knife (160) so that the knife (160) moves along the circumferential direction of the target roll (10). The operating part (220) may comprise an extension member (221), an operating member (222), and a support member (223).

Specifically, the operating part (220) comprises an extension member (221) having one end coupled to the operating shaft (143) of the driving gear (140) to rotate together with the driving gear (140). The extension member (221) has one end (221a) coupled to the operating shaft (143) of the driving gear (140). An operating member (222) is coupled to the other end (221b) of the extension member. The extension member (221) is installed in parallel with the target roll (10) along the longitudinal direction of the target roll (10), thereby transmitting the rotational force of the operating member (222) to the driving gear (140). For example, the extension member (221) may be made of a flexible material.

In addition, the operating part (220) may comprise an operating member (222) which is coupled to the other end of the extension member (221) to provide the rotational force to the extension member (221) at a position spaced apart from the target roll (10).

The operating member (222) is coupled to the other end (221b) of the extension member (221) to rotate the extension member (221). As one example, the operating member may comprise a manually operated operation handle or a driving motor. The operating member (222) may be a manually operated operation handle. As another example, the operating member (222) may be a driving motor capable of adjusting the rotation direction and the rotation speed. In addition, the operating member (223) may be provided to be rotatable in a forward direction and a reverse direction.

The extension member (221) may be disposed to be spaced apart from the upper portion of the bottom surface of the installation place of the operating part (220). The extension member (221) may be positioned apart from the bottom surface by the support member (223). The support member (223) is installed on the bottom surface of the installation place to rotatably support the extension member (221).

The cleaning part (110) may further comprise a foreign material sensing part installed on the cleaning body (120) to sense the foreign substances (P) of the target roll (10).

The foreign material sensing part is installed in the cleaning body (120) to sense the foreign substances (P) of the target roll (10). The foreign material sensing part may be linked to a display part (not shown). A monitoring part is communicably connected to the foreign material sensing part, whereby it can display whether the target roll (10) has the foreign substances in real time.

Referring to FIGS. 8 and 9, upon operation of the operating part (220), if the worker rotates the operating member (222) in a predetermined direction at a position far from the target roll (10), the driving gear (140) coupled to the extension member (221) rotates in the same rotational direction (R1) as the rotational direction of the operating member, and accordingly, the rotational movement of the knives (160a˜160d) is performed, while the rotary gear (130) rotates.

At this time, the at least one knife (160a to 160d) may remove the foreign substances (P) present in the target roll (10). This process may be repeated by changing the position of the cleaning part (110) along the longitudinal direction (L) of the target roll (10).

One example of the present invention described above has been disclosed for the purpose of illustration, those skilled in the art and having ordinary knowledge of the present invention will be able to make various modifications, changes, and additions within the spirit and scope of the present invention, and such modifications, changes and additions shall be deemed to fall within the scope of the following claims.

### INDUSTRIAL APPLICABILITY

During the roll cleaning process, the worker can perform the cleaning work of the target roll in a space other than the space where the target roll requiring cleaning is installed, so that it is possible to perform the cleaning work of the target roll without being restricted by the space in which the target roll is installed.

1. A roll cleaning device, comprising:
at least one knife;
a cleaning part configured to surround a target roll and configured to contact an outer circumferential surface of the target roll on which foreign substances are present; and
an operating part connected to the cleaning part, the operating part configured to move the at least one knife in a circumferential direction along the outer circumferential surface of the target roll.

2. The roll cleaning device according to claim 1, wherein the cleaning part comprises:
a cleaning body configured to surround the target roll;
a rotary gear on which the at least one knife is mounted, the rotary gear disposed on the cleaning body, the rotary gear being rotatably mounted onto the cleaning body, each of the at least one knife being disposed along an inner circumferential surface of the cleaning body facing the target roll; and
a driving gear gear-coupled to the rotary gear, the driving gear coupled to an operating shaft that is connected to an operating part, the operating shaft configured to transmit rotational force from the operating part to the rotary gear.

3. The roll cleaning device according to claim 2, wherein the at least one knife to protrudes toward the target roll and extends within a movement passage defined within the inner circumferential surface of the cleaning body.

4. The roll cleaning device according to claim 3, wherein the at least one knife is a plurality of knives each coupled to the cleaning body, and the plurality of knives are spaced apart from one another at predetermined intervals along the inner circumferential surface of the cleaning body in the circumferential direction.

5. The roll cleaning device according to claim 3, wherein each knife has a blade part configured to contact the outer circumferential surface of the target roll, and each blade part is curved with a predetermined curvature.

6. The roll cleaning device according to claim 5, wherein each blade part is curved with a same curvature as that a curvature of the outer circumferential surface of the target roll.

7. The roll cleaning device according to claim 5, wherein each blade part is configured to be elastically movable relative to the cleaning body in a radial direction closer to or away from the target roll.

8. The roll cleaning device according to claim 2, wherein the cleaning body comprises:
a first body configured to surround a first portion of the target roll;
a second body configured to surround a remaining portion of the target roll that is not the first portion; and
a body hinge shaft configured to hinge-couple a first end of the first body to a first end of the second body.

9. The roll cleaning device according to claim 8, wherein the cleaning body comprises:
a first fastening member installed at a second end of the first body; and
a second fastening member installed at a second end of the second body and detachably coupled to the first fastening member.

10. The roll cleaning device according to claim 8, wherein the rotary gear comprises:
a first gear coupled to the first body;
a second gear coupled to the second body; and
a gear hinge shaft hinge-connecting the first gear and the second gear.

11. The roll cleaning device according to claim 10, wherein when the first body and the second body are separated on opposite sides of the body hinge shaft, and the first gear and the second gear are separated on opposite sides of the gear hinge shaft.

12. The roll cleaning device according to claim 2, wherein the operating part comprises:
an extension member having a first end coupled to the operating shaft, the extension member configured to rotate together with the driving gear; and
an operating member coupled to a second end of the extension member, the operating member configured to provide rotational force to the extension member at a position spaced apart from the target roll.

13. The roll cleaning device according to claim 12, wherein the operating member comprises a manually operated operation handle or a driving motor.

14. The roll cleaning device according to claim 12, wherein the operating member is rotatable about a longitudinal axis of the extension member in a forward direction and a reverse direction.

15. The roll cleaning device according to claim 2, wherein the cleaning part comprises a plurality of guide gears disposed within the cleaning body and rotatable relative to the cleaning body, the guide gears disposed apart from one another at predetermined intervals about the rotary gear in the circumferential direction, and the guide gears each being gear-coupled to the rotary gear.
